(19) United States
(12) Patent Application Publication
(10) Pub. No.: US 2008/0065506 A1
(43) Pub. Date: Mar. 13, 2008

(54) Centralised Online Ordering and Fulfilment Method and System

(76) Inventor: Paul Michael Shillington, Western Australia (AU)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/574,920

(22) PCT Filed: Sep. 16, 2005
(86) PCT No.: PCT/AU05/01414

§ 371 Date: Mar. 8, 2007

(30) Foreign Application Priority Data
Sep. 16, 2004 (AU) 2004905328

(51) Int. Cl. G06Q 30/00

(52) U.S. Cl. 705/26

(57) ABSTRACT

A centralised online ordering and fulfillment method and system for vendors to make available product or services for order by customers and for customers to order and pay for them. After logging in to the system, a customer will provide differing levels of information in relation to the product or service and the geographic location pertaining to the customer and order a product or service from a relevant vendor. The order is transmitted (32) from a server system to the relevant vendor for order fulfillment. The server system receives notification from the vendor of either or both of the receipt of the order (33) and the fulfillment of the order (35). The customer is notified of either or both of the receipt of the order (34) and the fulfillment of the order (37). Payment for the order is processed at the time of receiving the order (42) or at a time after receiving the order (43).

### FIELD OF THE INVENTION

The present invention relates to a method and system for a consumer to place an order with a business for an item, e.g. a commodity such as a product/s or service/s, via a centralised service using a global computer network, such as the Internet.

### BACKGROUND ART

The use of the Internet enables interconnected computers and other devices to exchange information, e.g. such as electronic mail and graphical information via the World Wide Web (www). This ability has led to web-based ordering of products by customers from businesses. Due to the individual and proprietary nature of such business websites, using this medium has usually required businesses to put in place the necessary infrastructure and resources required to vend their products via this medium. In addition, such business websites are not able to target their relevant local customers on the Internet, and conversely, it is difficult for customers to find local businesses that will provide trustworthy online services to that customer.

Many enterprises could benefit if they were not hampered by the barriers to them being able to implement such a system, and if their products and services were readily accessible for online transaction with relevant local customers. Thus, it is desirable that more enterprises that provide goods and services that potentially could be made available for sale in the web-based online environment and that could benefit from making them available in such a manner, were actually able to do so.

### DISCLOSURE OF THE INVENTION

In accordance with one aspect of the present invention, there is provided a method for receiving and processing an order for an item comprising:

providing a facility for vendors to make available items for order by customers,

providing a facility for customers to order and pay for items ordered by customers,

receiving an order for at least one item from a customer at the server system, information received at the server system pertaining to the order including information relating to a geographic location pertaining to the customer, the at least one item ordered and the relevant vendor from whom the item was ordered by the customer,

transmitting the order from the server system to the relevant vendor for fulfillment of the order,

receiving notification at the server system from the vendor of either or both of the receipt of the order and the fulfillment of the order,

notifying the customer of either or both of the receipt of the order and the fulfillment of the order, and

processing payment for the order at the time of receiving the order or at a time after receiving the order.

In one embodiment, the method further comprises incorporating information relating to a geographic location pertaining to the customer into means used by the customer to access the facility for customers to order and pay for items ordered by customers.

In another embodiment, the method further comprises, prior to receiving an order receiving information relating to a geographic location pertaining to the customer, and providing information relating to the relevant vendor from whom the customer is to order the item.

In the preceding embodiment, the information relating to a geographic location pertaining to the customer may be selected by the customer.

In another embodiment, the method further comprises, prior to receiving an order: providing information relating to the vendors, and receiving at the server system a selection made by the customer of at least one of the vendors as a relevant vendor from whom the customer is to order the item.

In the preceding embodiment, the method may further comprise incorporating information relating to a geographic location pertaining to the customer in the means used by the customer to access the facility for customers to order and pay for items ordered by customers.

In another embodiment, the method further comprises, prior to receiving an order: receiving information at the server system relating to a geographic location pertaining to a customer, and providing information relating to vendors in response to said information received at the server system relating to a geographic location pertaining to the customer.

In another embodiment, the method further comprises, prior to receiving an order: receiving information at the server system relating to at least one item selected by the customer, receiving information at the server system relating to a geographic location pertaining to a customer, and providing information relating to vendors in response to said information received at the server system relating to at least one item selected by the customer and the information relating to a geographic location pertaining to the customer.

In the preceding two embodiments, the information pertaining to a geographic location pertaining to the customer may be selected by the customer or is a default setting.

Preferably, the method further comprises, prior to receiving an order:

providing information relating to the items made available by the relevant vendor for order by a customer.

Preferably, providing a facility for vendors to make available items for order by customers includes receiving information from vendors to subscribe vendors to the facility.

Preferably, providing a facility for customers to order and pay for items includes receiving information from customers to subscribe customers to the facility.

Preferably, the method further comprises, at the time or after receiving an order: receiving at the server system information pertaining to the customer to uniquely identify the customer to the server system.

As hereinbefore described, facility is provided for customers to pay for items ordered by customers.

In one embodiment, processing payment for the order occurs after receiving the order from the customer. Alternatively, the processing payment for the order of the customer occurs after receiving notification at the server system from the vendor of the fulfillment of the order.

Preferably, processing payment for the order comprises debiting the cost of the order to an account of the customer.

Preferably, processing payment for the order further comprises crediting the cost of the order to an account of the relevant vendor.

Preferably, processing payment for the order comprises crediting the cost of the order less a service fee to the account of the relevant vendor.

Preferably, debiting the cost of the order to the customer account also comprises allocating reward points to the customer account.

Preferably, notifying the customer of either or both of the receipt of the order and the fulfillment of the order is performed by the server system.

Preferably, the method further comprises updating order fulfillment wait times for access by a customer.

In accordance with a second aspect of the present invention, there is provided a method for receiving and fulfilling an order for an item comprising:

subscribing to an order placement service under control of a server system,

receiving from the server system an order for an item placed with the server system by a customer,

fulfilling the order, and

notifying the server system of either or both of the receipt of the order and fulfillment of the order.

The method for receiving and fulfilling an order for an item as hereinbefore described also comprises receiving payment for the order for an item placed with the server system by a customer. Preferably, receiving payment for the order occurs after notifying the server system of fulfillment of the order. Alternatively, receiving payment for the order occurs after receiving from the server system an order for an item placed with the server system by the customer.

Preferably, the method in accordance with the second aspect of the present invention further comprises notifying the customer of either or both of the receipt of the order, and fulfillment of the order, placed by the customer.

In accordance with a third aspect of the present invention, there is provided a method for placing an order for an item comprising:

subscribing to an order placement service under control of a server system for a customer to order and pay for items ordered,

placing an order for at least one item with the server system, information sent to the server system pertaining to the order including information relating to a geographic location pertaining to the customer, at least one item ordered, the relevant vendor from whom the item was ordered and payment authorisation.

In one embodiment, the method further comprises incorporating information relating to a geographic location pertaining to the customer into means used by the customer to access the order placement service for a customer to order and pay for items ordered by the customer.

In another embodiment, the method further comprises, prior to placing an order: sending information to the server system relating to a geographic location pertaining to the customer, and receiving information relating to the relevant vendor from whom the customer is to order the item.

In the preceding embodiment, the information relating to a geographic location pertaining to the customer may be selected by the customer.

In another embodiment, the method further comprises, prior to placing an order: receiving information relating to the vendors, and sending to the server system a selection made by the customer of at least one of the vendors as a relevant vendor from whom the customer is to order the item.

In the preceding embodiment, the method further comprises incorporating information relating to a geographic location pertaining to the customer in the means used by the customer to access the order placement service.

In another embodiment, the method further comprises, prior to placing an order: sending information to the server system relating to a geographic location pertaining to the customer, and receiving information relating to vendors in response to said information sent to the server system relating to a geographic location pertaining to the customer.

In another embodiment, the method further comprises, prior to placing an order: sending information to the server system relating to at least one item selected by the customer, sending information to the server system relating to a geographic location pertaining to a customer, receiving information relating to vendors in response to said information sent to the server system relating to at least one item selected by the customer and the information relating to a geographic location pertaining to the customer.

In the preceding two embodiments, the information pertaining to a geographic location pertaining to the customer may be selected by the customer or is a default setting.

Preferably, the method further comprises, prior to placing an order receiving information relating to the items made available by the relevant vendor for order by a customer.

Preferably, the method further comprises, at the time or after placing an order: sending to the server system information pertaining to the customer to uniquely identify the customer to the server system.

The order placement server provides for a customer to pay for items ordered by the customer.

In one embodiment, the method further comprises, providing authorisation for the payment by the customer after placement of the order by the customer. Alternatively, authorising of the payment for the order of the customer occurs after receiving notification at the server system of the fulfillment of the order.

The method for placing an order for an item as hereinbefore described also comprises making payment for the order for an item placed with the server system by the customer. Preferably, payment for the order occurs after the vendor has notified the server system of fulfillment of the order. Alternatively, payment for the order occurs after the server system transmits an order to the vendor for an item placed with the server system by the customer.

Preferably, the method in accordance with the third aspect of the present invention further comprises the server system notifying the customer of either or both of the placement of the order with the vendor, and fulfillment of the order by the vendor.

Preferably, the method in accordance with the third aspect of the present invention further comprises the customer providing feedback to the server system on the performance of the vendor.

In accordance with a fourth aspect of the present invention, there is provided a system to enable an item to be ordered and paid for comprising a server engine, a vendor database, a customer database, an auditable item database for each of the vendors in the vendor database, and an order database for each vendor in the vendor database wherein an order for at least one item is received at the server engine which transmits the order from the server engine to the relevant vendor for fulfillment of the order.

The method in accordance with the first aspect is the operation of the centralised online ordering and fulfillment method of the present invention from the stand point of the server system, whilst the method in accordance with the second aspect is from the stand point of a vendor and the method of the third aspect is from the stand point of a customer using the system. The described features of the methods in accordance with the first, second and third aspects of the present invention can also be combined as a method of operating the centralised online ordering and fulfillment method from these three stand points as a further aspect of the invention.

### BRIEF DESCRIPTION OF THE DRAWINGS

The present invention will now be described, by way of example, with reference to the accompanying drawings, in which:

FIGS. 1a and 1b shows a flow diagram illustrating embodiments of the method of the present invention; and

FIG. 2 is a block diagram showing the functional components of a system for implementing the method in accordance with the present invention.

### BEST MODE(S) FOR CARRYING OUT THE INVENTION

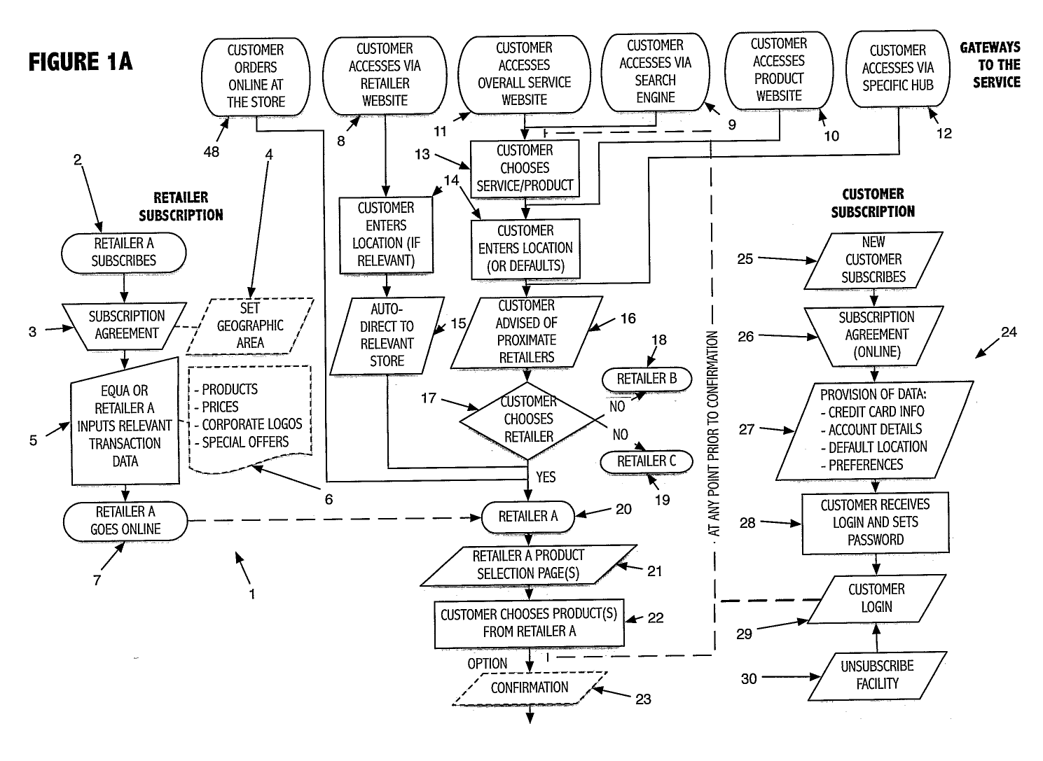

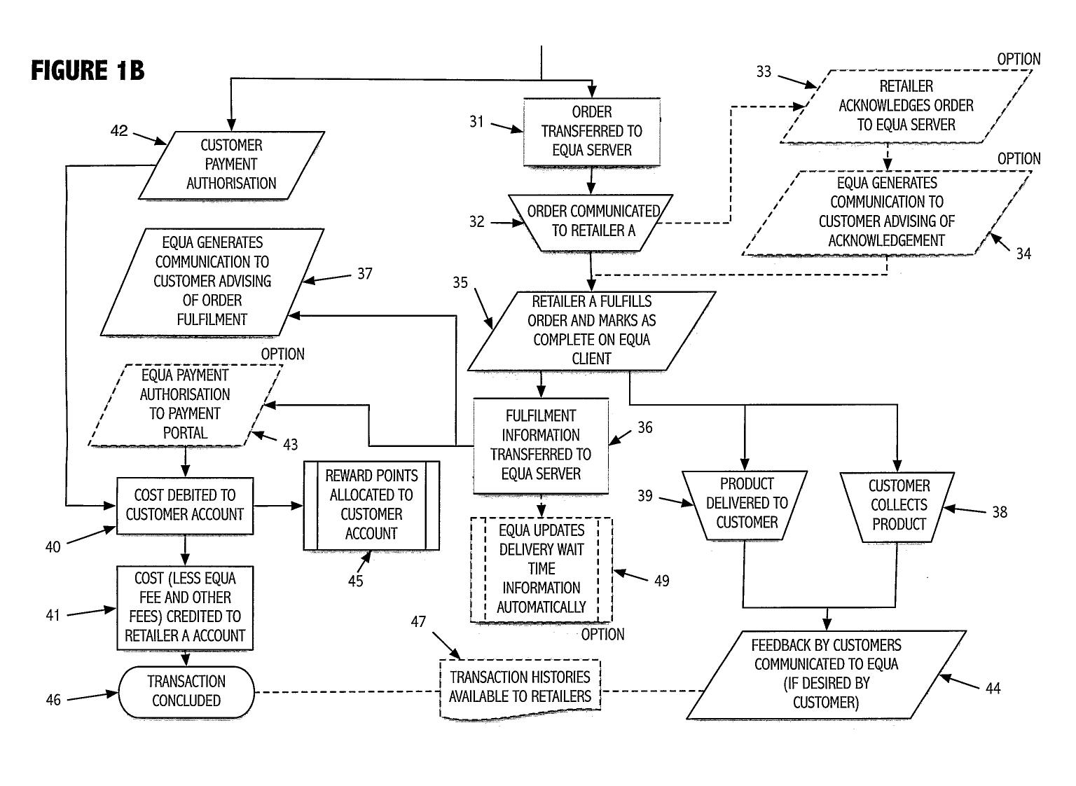

The present invention will now be described with particular reference to FIG. 1.

In accordance with the present invention, subscriptions are received by a service operator (also referred to as eQua in the drawings) from vendors which provides a facility for vendors to offer, i.e. make available items (such as their products and/or services) for order by customers via a centralised Internet-based system operated by the service operator. This subscription process is shown in the shaded box 1 in FIG. 1. By way of example, a vendor or retailer, A is contacted and offered a subscription, or alternatively, the vendor A may apply (online or via other means) for a subscription to the system (Step 2). Upon completion of the required formalities, such as execution of a subscription agreement (Step 3) and setting the geographic areas (Stop 4) in which the vendor A is to provide its products and/or services, the relevant details of the vendor A are entered into the system (Step 5). These details include an identification of Fe vendor A, the products and/or services that the vendor A is offering, the prices of these products and services, corporate logos, special offers that the vendor A may wish to make to potential customers along with any other required information (reference numeral 6). These details can, from time to time, be altered as required. Upon completion of these formalities, the details required for the internet-based ordering system are entered into the server system that controls the internet-based ordering system (Step 7). Once this has been done, customers accessing the service are able to view the details of vendor A as web pages (or equivalent).

Any number of vendors may subscribe to the service, operated by the service operator, in this manner. Accordingly customers may find relevant (and in particular, proximate) online vendors in a number of ways, namely:

a customer may access the facility to place an order at the location of the business of the vendor (Step 48);

a customer may access a proprietary web page placed by an individual retailer (or chain or franchise of retailers), and wishing to review and purchase an item, will hyperlink to the service (Step 8);

a customer may utilise a search engine or existing web portal to search for suitable vendors, and may hyperlink to the service from the search results provided by the search engine or portal (Step 9);

vendors that offer the same, or similar, products and services for sale to customers may be grouped under a suitably branded single web site (e.g. coffee, Mexican food, pizza delivery). In this way, a customer seeking to purchase a particular type of product, or service, is able to access a specific single web site for that product, or service, and make a selection of the vendor and the product, or service, that the customer seeks to purchase (Step 10);

vendors that subscribe to the service may be classified by the service operator into suitable categories (e.g. cafes, supermarkets, florists, etc) and published for easy location by customers via a single web site. A customer seeking to purchase a particular type of product, or service, accesses a single web site provided by the service operator and then makes a selection for the product, or service, which the customer seeks to purchase and then makes a selection of the vendor and their particular product, or service, that the customer seeks to purchase (Step 11);

businesses or organisations that wish to facilitate online ordering with proximate vendors (e.g. hotels wishing to make available to their guests online ordering for proximate restaurants and food delivery businesses) may create their own web sites that links to the service to allow ordering from the vendors that serve that geographic location (Step 12).

The above different approaches available to a customer will provide differing levels of information in relation to the product and/or service and the location of that customer. In all events, the customer will (either directly or via a hyperlink) enter the relevant URL for the web page that will connect with the centralised ordering service. The server of the centralised ordering service forwards the requested web page(s) to the computer of the customer. This web page is then displayed for the customer to view using the browser of the computer of the customer in the usual manner. The customer is then able to enter information regarding the order being placed.

In the event that the customer accesses the service by way of Steps 9 or 11, the customer would select the type of product, or service, in which the customer is interested in ordering (Step 13). Following on from this, or in the event that the customer accesses the service via Step 10, the customer then advises (whether by direct entry, selection from a menu, or by the service defaulting to specified data previously provided by the customer) information relating to a geographic location pertaining to the customer. Typically this will be information in relation to the geographic location of the customer (Step 14). Should the customer access the service via Step 8 (a vendor's proprietary web site), then the customer may provide the relevant geographic information in Step 14 either via the Service, or via a direct entry within the vendors proprietary web site (which already incorporates the geographic information) and which will redirect the customer to the nominated vendor that will fulfil the customers order (Step 15).

Upon receiving this relevant product/service and/or geographic information of the customer as mentioned above, or in the event that the customer accesses the service via Step 12 (a geographic hub web site which already incorporates the geographic information), the server of the centralised ordering service returns a web page to the customer's computer that lists the vendors that currently service that geographic area (Step 16). The customer selects a vendor for fulfillment of the order that the customer seeks to place (Step 17). For example, the customer may be presented with three vendors A, B and C. The customer may decide to not select vendors B and C (Steps 18 and 19) and instead select vendor A (Step 20).

If a customer has been automatically re-directed from a vendor's proprietary web site (Step 15 as mentioned above), the customer will not be required to make a choice as to vendors and will proceed directly to Step 20.

In addition to the customer making a selection of the vendor based on product/service and geographic information, other criteria may be provided to the customer on which to base a selection. For example, a web page may be returned to the customer that includes additional information, e.g. average wait time for a particular vendor to fulfil an order. This information may be included in the web page that is the returned to the customer's computer at Step 16.

Following selection of vendor A by the customer or an automatic redirection under Step 8, this information is transmitted to the server which then returns a web page(s) to the customer that lists the information about the products that can be ordered from vendor A (Step 21). This information will include an identification of the product and the price. The customer makes a selection of the product, or products to be ordered from vendor A (Step 22), and the customer may then confirm this selection via a confirmation web page or equivalent (Step 23).

At any point between initial access to the service by the customer up to confirmation (Step 23), the customer may log in to the service to uniquely identify the customer to the service, activating the various preferences and providing the necessary default information to the service server to allow the transaction to be processed. If the customer has not used the service previously, they will be required to follow the subscription process shown generally in the shaded box 24. The subscription process involves a new customer wishing to use the service (Step 25) being referred to a subscription web page operated by the service provider, which will contain terms and conditions for subscribing to the service as a customer (Step 26). The service will then seek relevant data from the customer to allow transactions to be processed (eg. identification, credit card details, default location of the customer etc) (Step 27), following which the service will provide a login and password for use by the customer with the service (Step 28). This login and password will be used for all vendor orders placed through the service (irrespective of the actual vendor who receives the order). Using this login and password, the customer may then process transactions through the service (Step 29). A customer may also request removal from the service via an unsubscribe facility (Step 30).

Upon receiving the order placed by the subscribed customer (Step 31), the server transmits the order to the computer system of vendor A (Step 32). Optionally (at the relevant vendor's discretion), the service may initiate a communication to the vendor requiring confirmation that the order has been received by the vendor (Step 33), and the service may also communicate that information on to the relevant customer (Step 34). Following receipt of the order, vendor A fulfils the order (Step 35). Fulfillment of the order may signify that the item ordered by the customer is ready for delivery to the customer or for collection by the customer. Following such fulfillment of the order, vendor A marks the order as having been fulfilled, or completed, and this automatically transmits data to the server of the service notifying the service that the vendor A has completed the order (Step 36). Notification is then sent to the customer, via the computer that the customer is using, that the order has been fulfilled. This may, for example, be done by the server of the service generating a notification, such as an email or instant message, to the computer of the customer notifying the customer of fulfillment of the order (Step 37). An alternative is that the web site of the service operated by the server posts an update of the delivery and wait times automatically. The customer is able to check on the status of the order. A further alternative is that the customer receives notification of the fulfillment of the order via SMS or some alternative non-Internet communication.

Optionally, as a service to customers, the service may use the data collected by the service in relation to the time taken between Steps 32 and 35 to publish (e.g. on the service's web page at Step 16, or in the communication at Step 34) an average wait time for fulfillment of orders by the relevant vendor (Step 49).

Upon fulfillment of the order, and notification provided to the customer, the customer is able to collect the order (Step 38). Alternatively, the item may be delivered to the customer at the customers nominated physical location (Step 39).

Following the data being transmitted to the server of the service (Step 36), the cost of the item is debited to the customer's account (Step 40). For accounting purposes, the cost of the item is credited to the account of vendor A. The cost credited may be the cost of the item less a subscription royalty and any other fees levied by the service to the vendor A (Step 41). Authorisation of this payment process by the customer would occur when the customer places the order (Step 42), and optionally, it may not be fully approved until the service server provides further authorisation following vendor confirmation that the order has been fulfilled (Step 43).

There may also be provision for feedback to the service from the customer following collection of the item by the customer (Step 38) or delivery of the item to the customer (Step 39). This feedback is shown at Step 44, and may be posted by the customer to the web site of the service. Feedback to the server from the customer is not restricted to being available following collection of the item or delivery of the item to the customer. Thus, in the event of non-collection of the item or non-delivery of the item, the customer may similarly provide feedback to the server. Typically, feedback in such cases would occur at some point after the order was expected to be delivered or collected.

This present invention also permits a customer to accumulate reward (or loyalty) points based on the purchases made with one or more vendors that subscribe to the service. Any such reward points that are collected by the customer are allocated after Step 40, and this is shown (Step 45). Following Step 41, the transaction is concluded (Step 46) from the point of view of the service. Tracking reports of the transaction and previous transaction histories (and metrics from such data) may be made available to the vendor A (Step 47).

Implementation of the present invention by a vendor does not preclude the purchase of items by a customer from that vendor in a face-to-face transaction. In such an “off-line” ordering process, a customer may place an order at the shop front of the business of the vendor in conventional manner (Step 48), previously herein described. The order of the customer is entered (either by the customer or by the vendor) via a keyboard, with the customer specifically entering log-in and password details for access to the account of the customer (the same effect as Step 29). The process then proceeds in the same manner as previously hereinbefore described from Step 20 onwards.

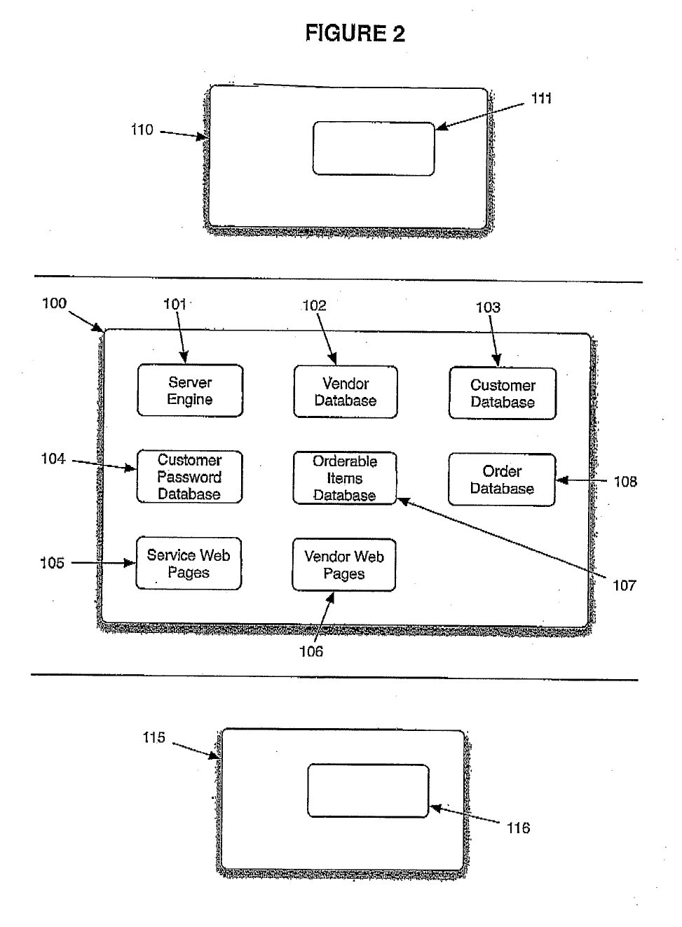

FIG. 2 shows an embodiment of a system that supports the method of the present invention and enables an item to be ordered using the Internet global computer system. The server system 100 comprises a server engine 101, a vendor database 102, a customer database 103, a client/password correlation database 104, web pages 106 of the service, web pages 106 for each of the vendors in the vendor database 102, an orderable item database 107 for each of the vendors in the vendor database 102 and an order database 108 for each vendor in the vendor database 102. The customer system 110 comprises a browser 111 which the customer uses to access and interact with the server system 100. Each vendor has a vendor system 115. Each vendor system 115 is able to receive information regarding orders from the server system 100 and notify the server system 100 (and the client system 110, if desired) of completion of the order. This may be done, for example, by an electronic mail facility, or a browser-type facility, 116 of the vendor system 115.

Whilst the present invention has hereinbefore been described with reference to the customer using a computer to interact with the server of the centralised ordering service, the invention is not restricted to the use of a computer by the customer. Thus, the customer may use any device that allows communication between the customer's device and the server. Thus, devices such as, for example, suitably function-enabled mobile telephones and personal digital assistants (PDAs) may be used.

The server engine 101 receives requests to access web pages from customers accessing the web site (any of Steps 8 to 12 and 48 inclusive). The vendor database 102 contains vendor information for various vendors that have subscribed to the service, such as the identification of the vendors, geographic information, e.g. areas in which each of the vendors is to provide its products and/or services, costs levied to vendors for subscription to the service, tracking data for the vendors representing orders placed by customers. The customer database 103 contains information in relation to customers, including customer identification, customer's billing and account information, customer reward points allocated. The customer/password database contains a correlation of customer identification and passwords for each customer who has registered with the service. The web pages 105 are the web pages of the service that are displayed to a customer accessing the web site of the service. These web pages 105 may include introductory web pages that the customer views for access to the service via Steps 9 or 11 as illustrated in FIG. 1, and may also include customised web pages for access via Steps 8, 10 or 12. At Step 17, the customer selects a particular vendor and from that point, i.e. Step 20, views web pages 106 that are specific to that particular vendor, although all still within the service itself. In addition, the web pages 106 may nevertheless be framed within a general service web page to maintain a degree of uniformity of presentation and also permit an advertising and monitoring presence to be maintained in the displays viewed by the customer (particularly for access by a customer through Step 11). The orderable database 107 contains information in relation to the items that may be ordered from each vendor and include other information such as prices. The order database 108 contains information for each order that has been placed with the service but has not yet been fulfilled to a customer. As orders are fulfilled, orders in the database 108 are satisfied to indicate completion, i.e. fulfillment of the order.

The present invention is applicable to a wide range of business enterprises. It allows businesses to make available their products and services via an online ordering system without having to establish their own individual e-commerce structures. Instead, they are able to subscribe to a centralised ordering service, without need to establish their own e-commerce structures, and nevertheless obtain benefits from conducting business in a web-based online environment. In addition, the service maps, or matches, customers based on geographic information, e.g. geographically proximate, to vendors, and provides a real-time transaction processing service.

By way of example, one implementation of the present invention is that small scale coffee shops may subscribe to the service. Each of the coffee shops is a vendor subscribing to the service. These coffee shops may be located in buildings in an urban environment. Customers may access the service web site (Step 11), or a building owner may create a mini-portal web site (Step 12), to enable customers to identify a vendor in proximity to their physical location. For example, the customer may be situated in one of the buildings in the urban environment. Accessing the web site of the service, or the building's mini-portal, the customer is able to identify open coffee shops within the proximity of the customer and place an order with that vendor (including payment) via the service. The vendor receives notification of the order placed by the customer (Step 32) and then proceeds to fulfil the order (Step 35) and the customer collects the coffee (Step 38) or it is delivered to the customer (Step 39).

The present invention may, similarly, be applicable to other businesses, e.g. pizza delivery, florists, restaurants, liquor stores, bakers, etc.

The present invention allows for payments to be made preferably by credit card, although also by other means such as direct debits or by using pre-paid amounts that have been paid to the service. Notification to customers of completion of the order (Step 37) may be by any suitable medium, e.g. live updates on the web site, SMS text messages, email, etc.

Modifications and variations such as would be apparent to a skilled addressee are deemed to be within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A method for receiving and processing an order for an item oharacterised in that it comprises:
providing a facility for vendors to make available items for order by customers,
providing a facility for customers to order and pay for items ordered by customers,
receiving an order for at least one item from a customer at the server system, information received at the server system pertaining to the order including information relating to a geographic location pertaining to the customers the at least one item ordered and the relevant vendor from whom the item was ordered by the customer,
transmitting the order from the server system to the relevant vendor for fulfillment of the order,
receiving notification at the server system from the vendor of either or both of the receipt of the order and the fulfillment of the order,
notifying the customer of either or both of the receipt of the order and the fulfillment of the order, and
processing payment for the order at the time of receiving the order or at a time after receiving the order.

2. A method according to claim 1, characterised in that it further comprises incorporating information relating to a geographic location pertaining to the customer into means used by the customer to access the facility for customers to order and pay for items ordered by customers.

3. A method accord to claim 1, characterised in that it further comprises, prior to receiving an order: receiving information relating to a geographic location pertaining to the customer, and providing information relating to the relevant vendor from whom the customer is to order the item.

4. A method according to claim 3, characterised in that the information relating to a geographic location pertaining to the customer may be selected by the customer.

5. A method according to claim 1, characterised in that the method further comprises, prior to receiving an order: providing information relating to the vendors, and receiving at the server system a selection made by the customer of at least one of the vendors as a relevant vendor from whom the customer is to order the item.

6. A method according to claim 5, characterised in that it further comprise incorporating information relating to a geographic location pertaining to the customer in the means used by the customer to access the facility for customers to order and pay for items ordered by customers.

7. A method according to claim 1, characterised in that it further comprises, prior to receiving an order receiving information at the server system relating to a geographic location pertaining to a customer, and providing information relating to vendors in response to said information received at the server system relating to a geographic location pertaining to the customer.

8. A method according to claim 1, characterised in that it further comprises, prior to receiving an order: receiving information at the server system relating to at least one item selected by the customer, receiving information at the server system relating to a geographic location pertaining to a customer, and providing information relating to vendors in response to said information received at the server system relating to at least one item selected by the customer and the information relating to a geographic location pertaining to the customer.

9. A method according to any one of claims 7 or 8, characterised in that the information pertaining to a geographic location pertaining to the customer may be selected by the customer or is a default setting.

10. A method according to any one of the preceding claims, characterised in that it further comprises, prior to receiving an order: providing information relating to the items made available by the relevant vendor for order by a customer.

11. A method according to any one of the preceding claims, characterised in that providing a facility for vendors to make available items for order by customers includes receiving information from vendors to subscribe vendors to the facility.

12. A method according to any one of the preceding claims, characterised in that providing a facility for customers to order and pay for items includes receiving information from customers to subscribe customers to the facility.

13. A method according to any one of the preceding claims, characterised in that it further comprises, at the time or after receiving an order: receiving at the server system information pertaining to the customer to uniquely identify the customer to the server system.

14. A method according to any one of the preceding claims, characterised in that it further comprises processing payment for the order occurs after receiving the order from the customer.

15. A method according to any one of the preceding claims, characterised in that it further comprises processing payment for the order of the customer occurs after receiving notification at the server system from the vendor of the fulfillment of the order.

16. A method according to claim 14 or 15, characterised in that processing payment for the order comprises debiting the cost of the order to an account of the customer.

17. A method according to claim 16, characterised in that debiting the cost of the order to the customer account also comprises allocating reward points to the customer account.

18. A method according to any one of claims 14 to 17, characterised in that processing payment for the order further comprises crediting the cost of the order to an account of the relevant vendor.

19. A method according to any one of claims 14 to 17, characterised in that processing payment for the order comprises crediting the cost of the order less a service fee to the account of the relevant vendor.

20. A method according to any of the preceding claims, characterised in that notifying the customer of either or both of the receipt of the order and the fulfillment of the order is performed by the server system.

21. A method according to any of the preceding claims, characterised in that the method further comprises updating order fulfillment wait times for access by a customer.

22. A method for receiving and fulfilling an order for an item comprising:
subscribing to an order placement service under control of a server system,
receiving from the server system an order for an item placed with the server system by a customer,
fulfilling the order, and
notifying the server system of either or both of the receipt of the order and fulfillment of the order.

23. A method according to claim 22, characterised in that it further comprises receiving payment for the order for an item placed with the server system by a customer.

24. A method according to claim 23, characterised in that receiving payment for the order occurs after notifying the server system of fulfillment of the order.

25. A method according to claim 23, characterised in that receiving payment for the order occurs after receiving from the server system an order for an item placed with the server system by the customer.

26. A method according to any one of claims 22 to 25, characterised in that it further comprises notifying the customer of either or both of the receipt of the order, and fulfillment of the order, placed by the customer.

27. A method for placing an order for an item comprising:
subscribing to an order placement service under control of a server system for a customer to order and pay for items ordered,
placing an order for at least one item with the server system, information sent to the server system pertaining to the order including information relating to a geographic location pertaining to the customer, at least one item ordered, the relevant vendor from whom the item was ordered and payment authorisation.

28. A method according to claim 27, characterised in that it further comprises incorporating information relating to a geographic location pertaining to the customer into means used by the customer to access the order placement service for a customer to order and pay for items ordered by the customer.

29. A method according to claim 27, characterised in that if further comprises, prior to placing an order: sending information to the server system relating to a geographic location pertaining to the customer; and receiving information relating to the relevant vendor from whom the customer is to order the item.

30. A method according to claim 29, characterised in that the information relating to a geographic location pertaining to the customer may be selected by the customer.

31. A method according to claim 27, characterised in that it further comprises, prior to placing an order: receiving information relating to the vendors, and sending to the server system a selection made by the customer of at least one of the vendors as a relevant vendor from whom the customer is to order the item.

32. A method according to claim 27, characterised in that it further comprises incorporating information relating to a geographic location pertaining to the customer in the means used by the customer to access the order placement service.

33. A method according to claim 27, characterised in that it further comprises, prior to placing an order sending information to the server system relating to a geographic location pertaining to the customer, and receiving information relating to vendors in response to said information sent to the server system relating to a geographic location pertaining to the customer.

34. A method according to claim 27, characterised in that it further comprises, prior to placing an order sending information to the server system relating to at least one item selected by the customer, sending information to the server system relating to a geographic location pertaining to a customer, receiving information relating to vendors in response to said information sent to the server system relating to at least one item selected by the customer and the information relating to a geographic location pertaining to the customer.

35. A method according to claim 33 or 34, characterised in that the information pertaining to a geographic location pertaining to the customer may be selected by the customer or is a default setting.

36. A method according to any one of claims 27 to 34, characterised in that it further comprises, prior to placing an order: receiving information relating to the items made available by the relevant vendor for order by a customer.

37. A method according to any one of claims 27 to 36, characterised in that it further comprises, at the time or after placing an order sending to the server system information pertaining to the customer to uniquely identify the customer to the server system.

38. A method according to any one of claims 27 to 37, characterised in that it further comprises providing authorisation for the payment by the customer after placement of the order by the customer.

39. A method according to any one of claims 27 to 37, characterised in that it further comprises authorising of the payment for the order of the customer occurs after receiving notification at the server system of the fulfillment of the order.

40. A method according to any one of claims 27 to 39, characterised in that it further comprises notifying the customer of either or both of the placement of the order with the vendor, and fulfillment of the order by the vendor.

41. A method according to any one of claims 27 to 40, characterised in that it further comprises providing means for the customer to provide feedback to the server system on the performance of the vendor.

42. A system to enable an item to be ordered and paid for comprising a server engine, a vendor database, a customer database, an auditable item database for each of the vendors in the vendor database, and an order database for each vendor in the vendor database wherein an order for at least one item is received at the server engine which transmits the order from the server engine to the relevant vendor for fulfillment of the order.
